(19) United States
(12) Patent Application Publication
(10) Pub. No.: US 2025/0349192 A1
(43) Pub. Date: Nov. 13, 2025

(54) SYSTEM FOR REMOTELY MANAGING SECURITY ACCESS

(71) Applicant: Leidos Security Detection & Automation, Inc., Tewksbury, MA (US)

(72) Inventors: Nicholas E. Ortyl, III, Bedford, MA (US); Marshall Lupo, III, Barboursville, VA (US); James Knight Riordan, Falls Church, VA (US)

(21) Appl. No.: 18/797,106

(22) Filed: Aug. 7, 2024

Related U.S. Application Data
(60) Provisional application No. 63/645,052, filed on May 9, 2024.

(51) Int. Cl. G08B 13/196; G01V 3/12; G01V 5/226; G01V 8/00

(52) U.S. Cl. CPC G08B 13/19602; G01V 3/12; G01V 5/226; G01V 8/005

(57) ABSTRACT

Systems and methods for remotely managing security access without an attendant are discussed. More particularly, techniques for a bifurcated screening procedure that screens both individuals and objects entering or exiting a secure area are described. Multiple detection devices and sensors at a security checkpoint in a screening area, such as an enclosed room or other type of enclosure, communicate with a remote management system (RMS). In many instances, the screening procedure may take place completely unattended by human security personnel at the security checkpoint. The RMS provides for overall command and control of multiple scanning systems to provide an automated self-service security solution.

### RELATED APPLICATION

This application claims the benefit of, and priority to, U.S. Provisional Patent Application No. 63/645,052, filed May 9, 2024, entitled “System for Remotely Managing Security Access, the content of which is incorporated herein by reference in its entirety.

### BACKGROUND

In recent years, various types of inspection devices have been developed to assist in securing physical facilities. For example, computed tomography (CT) scanning systems have been developed to scan objects passing through on a conveyor belt in order to identify prohibited types of objects that are banned from a facility. The results of the scan may be programmatically and/or manually analyzed. Likewise, systems have been deployed, frequently at airports, that are used to perform full body scans using active millimeter wave (MMW) radio frequency technology to detect concealed objects made up of different types of materials.

### BRIEF SUMMARY

Embodiments of the present disclosure provide techniques for a bifurcated screening procedure that screens both individuals and objects entering or exiting a secure area. Multiple detection devices and sensors at a security checkpoint in a screening area, such as an enclosed room or other type of enclosure, communicate with a remote management system (RMS). In many instances, the screening procedure may take place completely unattended by human security personnel at the security checkpoint. The RMS provides for overall command and control of the self-service security solution. In some embodiments, the RMS uses open API interfaces to link the results of multiple scanning systems and client services to a single unified security solution. The RMS can initiate a case ID for each self-service entry or exit event or both. During the screening process the case ID may be collated with results from each sensor (i.e., scanning systems as well as other sensors) at each screening process step to provide remote monitoring, and ultimately provide the final acceptance criteria for clearance.

In one embodiment, a computing device-implemented method for automatically managing access to and from a restricted area without an attendant where the computing device includes at least one processor, includes granting an individual access to a screening area from one of an unrestricted area or a restricted area, the screening area being disposed between the unrestricted area and the restricted area. The method also includes identifying at least one object associated with the individual and performing, in the screening area, an object scan of the at least one object using an object scanner communicatively coupled to a remote management system (RMS). The at least one object is placed into a tray associated with the object scanner and the tray is moved through the object scanner based on whether the individual is moving from the unrestricted area to the restricted area or from the restricted area to the unrestricted area. When the individual is moving from the unrestricted area to the restricted area, the tray is moved through a scanning chamber of the object scanner from a first position to a second position while scanning the tray. When the individual is moving from the restricted area to the unrestricted area, the tray is moved through the scanning chamber of the object scanner from the second position to the first position while scanning the tray. The method further includes performing, in the screening area, a body scan of the individual using a whole body scanner communicatively coupled to the RMS and, responsive to the body scan of the individual passing a body scan clearance protocol and responsive to the object scan of the at least one object associated with the individual passing an object scan clearance protocol, the RMS automatically granting the individual access to the other of the unrestricted area or the restricted area that is different from the area from which the individual accessed the screening area.

In another embodiment, a system for automatically managing security access, the system includes a body scanner to scan an individual and an object scanner to scan at least one object associated with the individual. The system further includes an object identification system to identify the at least one object associated with the individual and a processing system. The processing system includes a memory holding computer readable instructions and a processing device for executing the computer readable instructions. The computer readable instructions control the processing device to perform operations including granting the individual access to a screening area from one of an unrestricted area or a restricted area, the screening area being disposed between the unrestricted area and the restricted area. The operations further include identifying, using the object identification system, at least one object associated with the individual and performing, in the screening area, an object scan of the at least one object using the object scanner. The at least one object is placed into a tray associated with the object scanner and the tray is moved through the object scanner based on whether the individual is moving from the unrestricted area to the restricted area or from the restricted area to the unrestricted area. When the individual is moving from the unrestricted area to the restricted area, the tray is moved through a scanning chamber of the object scanner from a first position to a second position while scanning the tray. When the individual is moving from the restricted area to the unrestricted area, the tray is moved through the scanning chamber of the object scanner from the second position to the first position while scanning the tray. The operations additionally include performing, in the screening area, a body scan of the individual using the body scanner and responsive to the body scan of the individual passing a body scan clearance protocol and responsive to the object scan of the at least one object associated with the individual passing an object scan clearance protocol, automatically granting the individual access to either of the unrestricted area or the restricted area.

### BRIEF DESCRIPTION OF THE DRAWINGS

The accompanying drawings, which are incorporated in and constitute a part of this specification, illustrate one or more embodiments of the invention and, together with the description, help to explain the invention. In the drawings:

FIG. 1A depicts an exemplary screening area environment suitable for practicing one or more embodiments of the present invention;

FIG. 1B depicts an exemplary network environment suitable for practicing embodiments;

FIGS. 2A-2G graphically depict the screening process for an individual and objects in an exemplary embodiment;

FIG. 3A depicts an object scanner in an exemplary embodiment;

FIG. 3B depicts a whole body scanner in an exemplary embodiment;

FIG. 3C depicts a display of information to guide the pose of an individual in a whole body scanner in an exemplary embodiment;

FIG. 4 depicts an exemplary computing device suitable for use in one or more embodiments; and

FIG. 5 depicts an exemplary sequence of steps performed to screen individuals and objects in an exemplary embodiment.

### DETAILED DESCRIPTION

Secure facilities or secure areas such as, but not limited to data centers, are required to balance the need for physical access by individuals authorized to access the facility or area against a mandate to keep any proprietary data with which they are entrusted safe. Conventionally, this has required screening both the individuals seeking access to the facilities and examining any objects the individuals are attempting to bring with them into or out of the facility. In today's digital world, this screening for objects extends to also ensuring that any objects that could be used to transmit or remove electronic data from the facility are identified during the screening process. Traditionally, this screening process has involved a combination of detection devices and human personnel at the security checkpoint, with the human personnel operating the devices, overseeing their analysis and interacting with the individuals seeking access to the facility.

Conventionally, employees and vendors requiring access to a secure area of a facility, such as a restricted portion of a data center, have had to undergo a lengthy manual process requiring screening first by the individual walking through a metal detector and then frequently undergoing a second examination by a security officer with a handheld wand. This process is time consuming and not always dependable. For example, each examination may take several minutes for an employee to enter or exit the facility. Further, the second examinations can vary in thoroughness depending on training and attitude of the security officer. Similar problems exist with the examination of materials being brought into or out of the facility as they depend on detection device operator attention and skill. Similar to the inspection of the individual, the inspection of objects can also be quite time consuming.

Embodiments address these challenges in conventional screening practices by providing systems and methods for remotely managing security access to a facility or area in a manner that does away with the need for a human security officer to be stationed at every security checkpoint while increasing accuracy of results and expediting the screening process. More particularly, embodiments utilize a screening area, a whole body scanner, one or more detection devices and a remote network management system to control access to a facility without the need for a permanently stationed human security officer at the screening area.

Embodiments provide a bifurcated screening process that is a dual track screening of the individuals and the objects that are coming into, or out of, the facility. In one embodiment, a security checkpoint is a secure screening area/screening room used to perform the screening of both the individual and objects. In an embodiment, screening of the objects takes place first followed by clearance of the individual so that in the event an unauthorized object is detected, it may be addressed prior to screening the individual. In other embodiments, the two screenings may be conducted in parallel to expedite the screening process. Of note, in some embodiments, the screening process may occur completely unattended by human security officers at the security checkpoint as discussed further below. The systems and methods taught herein provide an ability to visually identify an object brought into and out of a secure area, an ability to identify an object brought into and out of a secure area via X-Ray and an ability to identify an object brought into and out of a secure area via near field identification, for example, Radio Frequency Identification (RFID) or Near Field Communication (NFC) or both. Some or all of these abilities to identify an object can be used as taught herein.

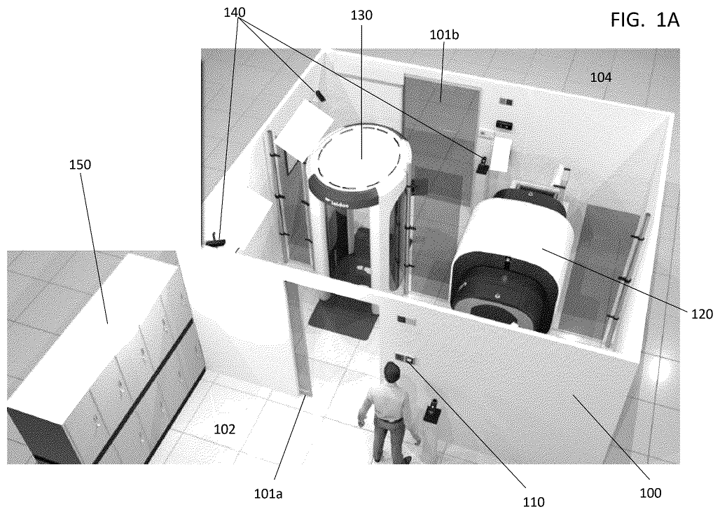

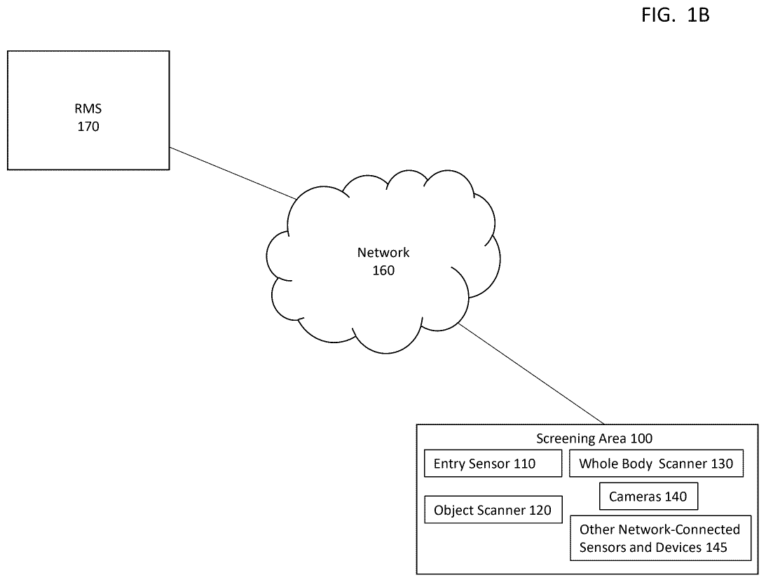

An exemplary security checkpoint with a screening area 100 located between an unsecured area 102 and secured area 104 is depicted in FIG. 1A. In an embodiment, the screening area 100 has a programmatically lockable entry 101a and exit 101b that restricts access into and out of the screening area at designated times. A number of sensors and/or detection devices are deployed near or in screening area 100 and communicate with RMS 170 over a network 160 as depicted in FIG. 1B (discussed further below). One of the sensors can be a Radio Frequency (RF) sensor to monitor for an object brought into the screening area that is emitting RF emissions. Another sensor can be a motion sensor to help monitor motion in the screening area. In one embodiment, the sensor may perform trace detection of explosives or drugs. For example, in one embodiment, an entry sensor 110 is used by an individual seeking to enter the facility to start the screening process. For example, the entry sensor 110 may be a biometric sensor such as a fingerprint reader, palm scanner or retinal scanner or may be another type of scanner such as a network-connected barcode scanner configured to read a barcode on an employee badge so that the scanned data may be compared against a list of approved individuals. Similarly, facial recognition technology may be used to determine the identity of individuals looking to access the facility. It will be appreciated that other types of devices may also be used within the scope of the present invention as entry sensor 110, including, but not limited to, devices able to detect RFID or NFC signals transmitting identity information. Further, other options such as network connected tablets or workstations that enable the individual to manually enter identity information which may include a password may also be employed. Additionally, in one embodiment, an intercom may be provided to allow for remote communication with a human guard force.

As will be explained more fully throughout, once in screening area 100, the individual and whatever objects the individual hopes to bring into (or out of) the facility undergo screening. In one embodiment, object screening is conducted with the aid of a network-connected object scanner 120 connected to RMS 170 that scans objects in trays passing through the scanner to identify prohibited objects such as but not limited to USB devices, solid state drives, hard disk drives, mobile phones, smart watches, weapons, sharp objects and/or powders (e.g. drugs or explosives in powdered form) etc. that the facility operator wishes to keep out of the facility. The scanned image may be analyzed programmatically and algorithmically cleared at object scanner 120 or the image may be provided to RMS 170 for further programmatic processing or human analysis. In an embodiment, the list of prohibited objects may include USB-A devices. In one embodiment, object scanner 120 is a Clearscan™ detection system from Leidos that combines CT scans with contraband detection algorithms.

In one embodiment, an RF emission detector may also be employed to scan each set of objects and individuals prior to entry and exit, to and from the facility. In an embodiment, the RF emission detector may monitor for RF emission sources in the 802.11 and mobile phone frequency range and may communicate findings to RMS 170. In some embodiments, an electromagnetic scan detects electromagnetic frequencies from ˜400 MHz to 6 GHz.

Embodiments may include a whole body scanner 130 that uses MMW radio frequency technology to detect concealed objects made of a variety of materials. For example, without limitation, objects that may be detected by whole body scanner 103 include USB devices, solid state drives, hard disk drives, mobile phones, smart watches, weapons, sharp objects and powders (e.g. drugs or explosives in powdered form) etc. that the facility operator wishes to keep out of the facility. Whole body scanner 130 may be equipped with entry and exit light curtain detectors that detect larger objects being thrown through the scanner that provide a break in the curtain in an attempt to bypass inspection and/or may employ RF modules to detect smaller objects such as mini USBs and Yubi keys tossed through the opening. In some embodiments, whole body scanner 130 may employ integrated cameras to further detect objects being tossed through the scanner. In some embodiments, the light curtains may employ colored light to indicate status to the individual as to which entry they may proceed through. In one embodiment, whole body scanner 130 is a Provision 3™ scanner from Leidos.

In some embodiments, screening area 100 may employ multiple cameras 140 connected to RMS 170 that capture images of the individuals and objects that enter screening area 100. In addition to providing input data to RMS 170, cameras 140 may provide a real-time view of screening area 100 to human security personnel stationed at the RMS, if so stationed, and also may provide a deterrent effect to those individuals entering and exiting the facility as they will know they are being monitored.

A storage area 150 outside of the entrance of screening area 100 may be provided for individuals to store any objects such as unauthorized objects/devices and other non-essential objects that they know are non-approved for being taken into the facility prior to beginning the screening process. In one embodiment, storage area 150 may be secure (lockable) lockers.

FIG. 1B depicts an exemplary network environment suitable for practicing embodiments. RMS 170 includes one or more computing devices which communicate over network 160 with sensors and detection devices in screening area 100. For example, RMS 170 may receive data from, and transmit data and instructions to, entry sensor 110, object scanner 120, whole body scanner 130, cameras 140 and other types of network-connected sensors and devices 145 located in, or in proximity to, screening area 100. Network 160 may be, without limitation, a Local Area Network, Wide Area Network or the Internet. Network 160 may be a wired or wireless network.

RMS 170 provides overall command and control and communicates with the detection devices, cameras and other sensors, in and in proximity to screening area 100 such as, but not limited to, entry sensor 110, object scanner 120, whole body scanner 130, cameras 140. In some embodiments, RMS 170 initiates a case ID for each entry/exit event. Data received during the screening process is collated with results from each sensor, process and client monitoring and is used to provide the final acceptance criteria for each entry/exit.

RMS 170 includes one or more computing devices equipped with one or more processors and is configured to execute one or more analysis algorithms using input data received from the sensors and devices in and in proximity to screening area 100. RMS 170 may use one or more artificial intelligence algorithms for analyzing raw data and/or full or partial results received from the sensors and devices in and in proximity to screening area 100 and for generating instructions to the one or more sensors and devices based on the analysis. For example, in some embodiments RMS may generate commands to lock and unlock entry 101a and exit 101b based on its analysis or send instructions to display devices in screening area 100 to display commands to the individual based on the results of individual and/or object inspection.

It should be appreciated that in some instances, RMS 170 may receive the results of an analysis performed by the sensors and devices in or in proximity to screening area 100 and generate instructions based on those results and in other instances may receive raw data and/or partial analysis information from the sensors and devices in or in proximity to screening area 100 so that RMS can perform analysis/further analysis based on the received raw data/partial analysis. For example, in some embodiments, object scanner 120 may reach an ambiguous result and send an image of the objects being scanned and/or analysis result to RMS 170 for additional human or programmatic processing. In some embodiments, RMS 170 creates records of threat detections. In some embodiments, RMS 170 may include a display device allowing a human operator to view images of the objects in object scanner 120 and determine either alone or in combination with further algorithmic processing performed at the RMS whether the viewed objects constitute a prohibited object. In some embodiments, only scans triggering alarms are shown to the human operator so that the operator does not have to sift through clear results.

In one embodiment, RMS 170 may include, or have access to one or more databases with pre-defined criteria and data relating to objects and an individual's permissions to access the facility. Without limitation, such pre-defined criteria may relate to lists of object types prohibited and allowed in the facility and individuals cleared or banned from the facility. In some embodiments, RMS 170 may use open API interfaces to link the results and/or data received from one or more scanning systems and client services.

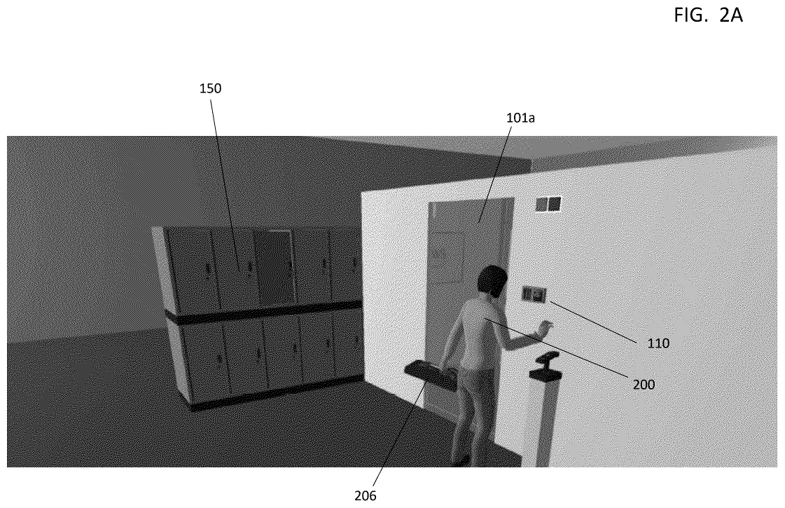

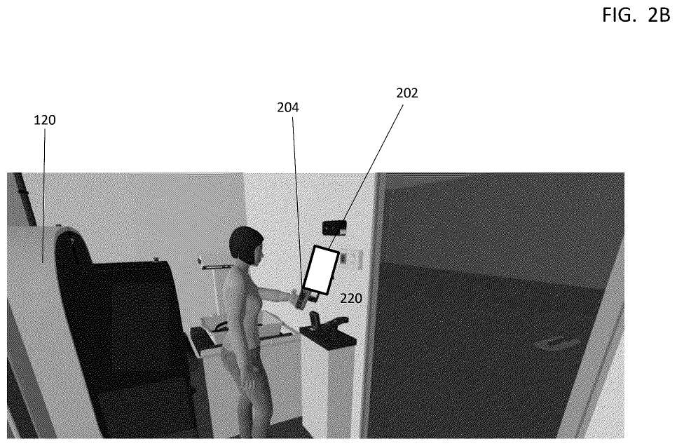

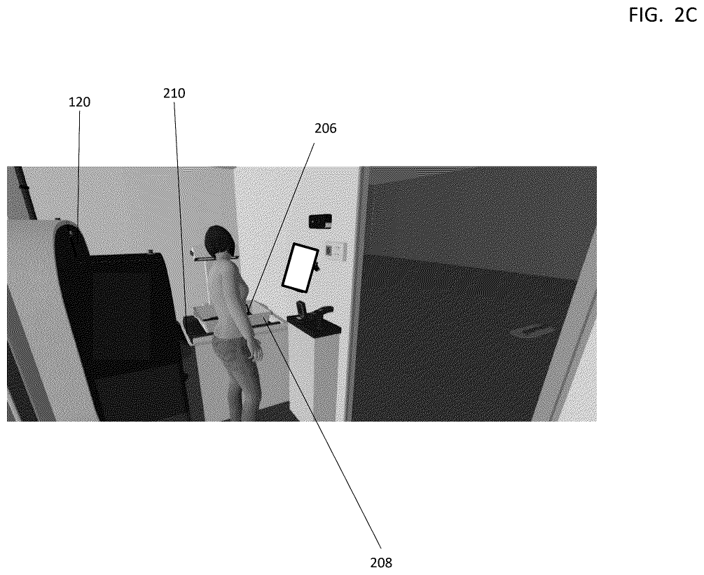

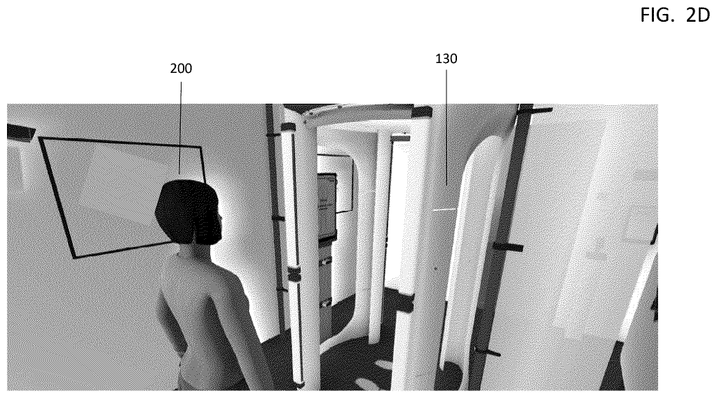

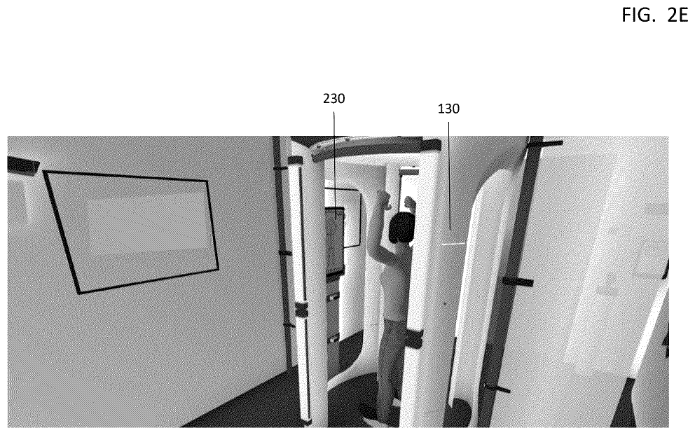

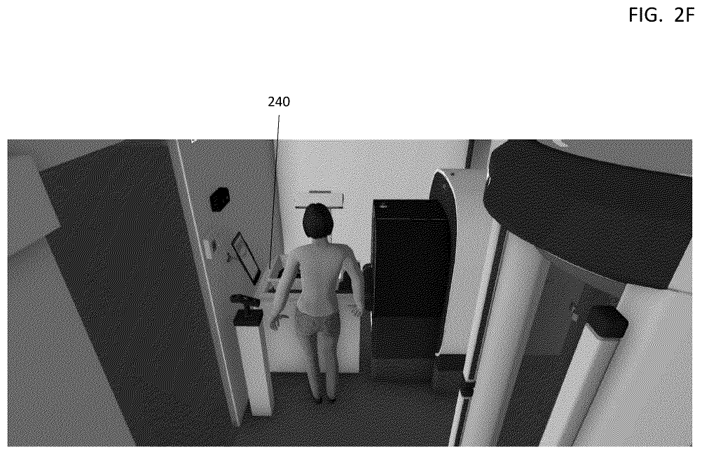

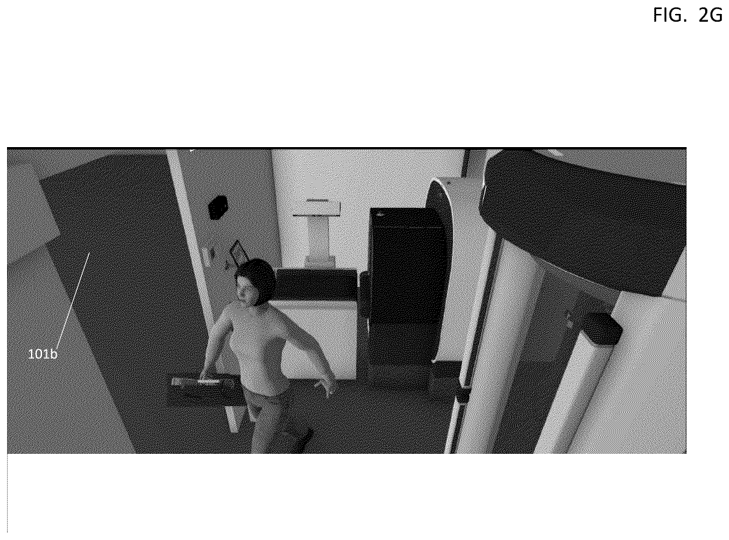

FIGS. 2A-2G graphically depict the screening process for an individual and objects in an exemplary embodiment. In an exemplary embodiment, the screening process for an individual looking to enter a secure area begins prior to the formal clearance process with the individual undergoing a pre-screening divestiture of any unneeded and/or unauthorized objects into secure storage location 150. As depicted in FIG. 2A, following this pre-screening divestiture of the unneeded/unwanted objects into secure storage location 150, individual 200 approaches entry sensor 110 holding the objects 206 that the individual wishes to bring into the secure area such as but not limited to approved tools in a toolkit, laptops, tablets, watches, portable electronic storage devices, analyzers, other instruments and so on. As individual 200 approaches entry sensor 110, entry 101a is in a closed and locked position preventing access to screening area 100. As noted above, entry sensor 110 may take many forms running from a workstation to a keycard scanner to a biometric sensor. After providing identifying input to entry sensor based on the type of sensor, the input data is transmitted to RMS 170 to determine if individual 200 is authorized to enter screening area 100. In the event individual 200 is authorized to enter screening area 100, RMS 170 sends a command to unlock/open entry 101a. Upon entry 101a opening, individual 200 enters screening area 100 while carrying objects 206 to begin the screening process. In some embodiments, upon entry by individual 200 into screening area 100, entry 101a is programmatically locked until conclusion of the screening process. In an embodiment, only a single individual at a time is allowed into screening area 100. In some embodiments, upon a threat being detected RMS 170 sends instructions to lock the doors until a security agent arrives. In an embodiment, a security guard is authorized to override the system in case there is a need for people to enter or exit the area in a quick manner (e.g., in a data center IT situation where a repair team needs to get in fast and company policy bypasses the screening process).

In one embodiment, as depicted in FIG. 2B, upon entry into screening area 100, individual 200 proceeds to divest station 220 located in the interior of the screening area. Divest station 220 may take a number of forms but in one embodiment, includes both a display 202 and a bar code scanner 204. In an embodiment, the display indicates the divest requirements and requires the individual to select objects for entry to the facility. The display includes a list of whitelist (approved) objects for the individual to select and an option for exception objects that may be barcode scanned by the integrated bar code scanner 204. Exception objects may be, for example, new objects that are allowed but are not yet in the database or objects that the guard staff can ‘ok’ via policy like hand tools or small step stools. The objects entered are logged and transmitted to object scanner 120 and/or RMS 170 for their use in subsequently analyzing the objects that are being examined by the object scanner to see if the selected objects match the objects traversing the object scanner. It will be appreciated that many different ways of selecting the objects proposed for transit into the facility may also be utilized, alone or in combination, within the scope of the present invention such as each object being identified via image recognition, optionally with individual confirmation.

As depicted in FIG. 2C, after identifying objects 206 at divest station 220, individual 200 divests themselves of the objects by placing the objects into or onto a receptacle 208, such as but not limited to a tray, container, bucket, for transit via conveyor 210 into object scanner 120. In some embodiments, camera 140 captures images of objects 206 as they are placed into/onto receptacle 208 and programmatic image recognition is performed as an additional verification check. More specifically, in some embodiments camera 140 may capture a photo of each tray and provide the resulting image to RMS 170 for attachment to the object scan. While the tray is processed by object scanner 120, the optical image is evaluated in order to confirm objects in the tray match the declared whitelist and exception objects entered at the divest station display. Results of the object recognition will be provided to RMS 170 for attachment to the case ID for each scanned tray. In some embodiments, the system thus combines optical cameras that perform external comparisons and CT images that are used to perform internal comparisons in order to verify object identity. For example, such a combination allows a Fluke digital multimeter (DMM) to be distinguished from a Keysight.

The object recognition and analysis performed during screening will result in the objects either being found to be authorized (in which case they may be taken into or out of the secure area) or unauthorized. In the event the objects are found to be unauthorized, a number of resulting actions may be taken. For example, RMS 170 and/or object scanner 120 may generate instructions to the individual to remove the object from receptacle 208 and place the object in secure storage 150 and/or contact security. The generated instructions may be delivered in a number of different ways including, but not limited to, by display on a display device or delivered audibly to the individual via a speaker present in object scanner 120 and/or screening area 100. In some embodiments, after the instructions have been delivered to the individual, the system can then re-check receptacle 208 either via cameras 140 or within object scanner 120 to see if the unauthorized object has been removed or not. In some embodiments, sensors and devices in screening area 100 track the individual exiting and returning to begin the screening process again. In some embodiments, depending on the nature of the unauthorized object, the individual may be given only a pre-determined number of chances to successfully have their objects and/or body scanned and authorized before human security personnel are dispatched and screening area 100 is locked. In other embodiments, one detection of an unauthorized object of a certain type may be enough to lock screening area 100 and dispatch personnel.

In some embodiments, in parallel with the image recognition or in isolation, an RF emission detector may sample the tray contents prior to X-ray screening. The RF emission detector may also monitor the room looking for unwanted emitters. It will be appreciated that the order of events may be reversed with individual 200 first divesting objects 206 into/onto receptacle 208 and then identifying them at divest station 220. In some embodiments, once the objects have been identified at divest station 220 and placed into/onto receptacle 208, individual 200 may start object scanner 120 via a button press or other provided means and proceed to whole body scanner 130 as depicted in FIG. 2D. In other embodiments, the act of individual 200 walking away from object scanner 120 may be captured by camera(s) 140 or other sensors and RMS 170 may start the object scanner and a conveyor to move the receptacle 208 into the object scanner 120 when the individual approaches whole body scanner 130. In further embodiments, no entry to whole body scanner 130 or further inspection of objects 206 may be authorized until a successful RF emission result. Those skilled in the art will appreciate a conveyor can be used to move the receptacle 208 into the object scanner 120 and likewise the object scanner 120 includes a conveyor to move the receptacle into and out of the object scanner. In some embodiments, there can be a single conveyor and in some embodiments there can be multiple conveyors. In some embodiments, the directionality of the conveyor can be controlled by detection or determination of which access door opens. For example, if RMS 170 detects that the door 101a opens it is an indication that the individual is entering the screening area from the unsecured area 102 and instructs the object scanner 120 to move the conveyor in a first direction. Likewise, if RMS 170 detects that the door 101b opens it is an indication that the individual is entering from the secure area 104 and can instruct the object scanner 120 to move the conveyor in a second direction. RMS 170 can keep track of when the doors 101a/101b open and close and also keep track of the time between opening and closing of each door to determine if the individual is entering or leaving the secure area.

As previously discussed, and depicted in FIG. 2E, whole body scanner 130 may use MMW technology to examine individual 200 for hidden unauthorized objects. In one embodiment, whole body scanner 130 may include display 230 providing pose instructions. In some embodiments, whole body scanner 130 may use light colors and/or audible or written displayed instructions to inform individual 200 when they may exit the scanner and proceed to the facility.

As depicted in FIG. 2F, upon successfully passing the inspection in whole body scanner 130, individual 200 proceeds to collection area 240 to collect objects 206 that have been successfully scanned. In some embodiments, in the event of objects 206 being found to be not authorized for the facility, conveyor 210 reverses and returns the objects to the starting point for individual 200 to return them to secure storage location 250 and begin the screening process again. In other embodiments, which may depend upon the nature of the unauthorized object, the objects are held within object scanner 120 and human security personnel are dispatched by RMS 170 to screening area 100 to further investigate. In some embodiments, there is no option for the individual to cure an issue detected by the object scanner 120.

As depicted in FIG. 2G, upon both individual 200 passing a body scan clearance protocol and objects 206 passing an object scan clearance protocol as determined by RMS 170, the RMS sends a command to unlock exit 101b and the individual and their associated objects enter the facility.

It should be appreciated that in certain embodiments object scanner 120 may examine objects 206 in parallel with individual 200 being examined at whole body scanner 130 to increase the speed of the screening process. However, in another embodiment, object scanner 120 may first examine objects 206 before individual 200 is examined by whole body scanner 130 so that in the event of the detection of specified types of unauthorized objects individual 200 can be instructed to remove the objects from screening area 100 and restart the process before undergoing a whole body scan.

Although FIGS. 2A-2G depict exemplary embodiments of an individual attempting to enter the facility, it should be appreciated that a similar process may be performed for individuals exiting the facility. For example a divest station may also be provided near exit 101b where the individual can declare and divest any objects they wish to remove from the facility. The proposed objects for removal may be placed into/onto a receptacle on conveyor 210 which is bi-directional for conveyance into object scanner 120 while the individual proceeds to whole body scanner 130 for an exit scan to make sure the individual is not hiding any unauthorized objects such as, but not limited to, data storage devices.

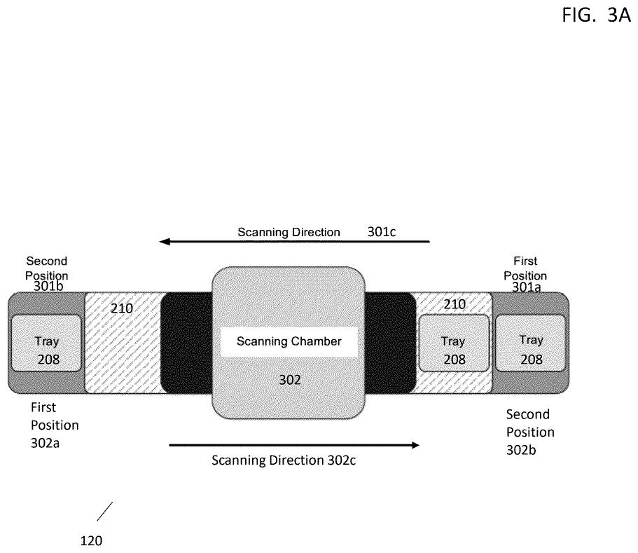

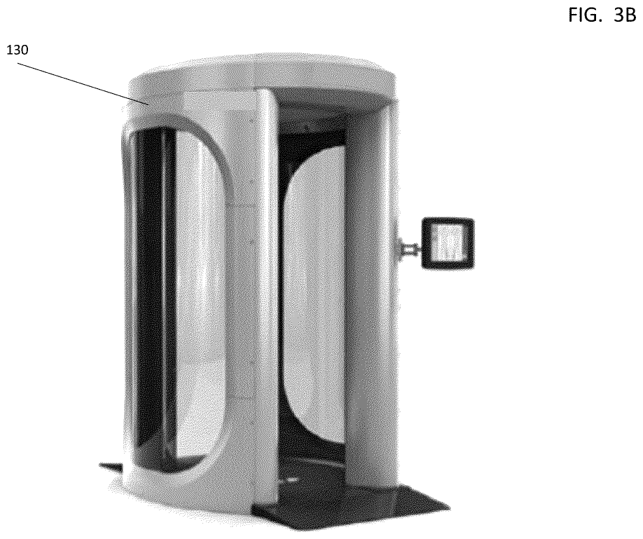

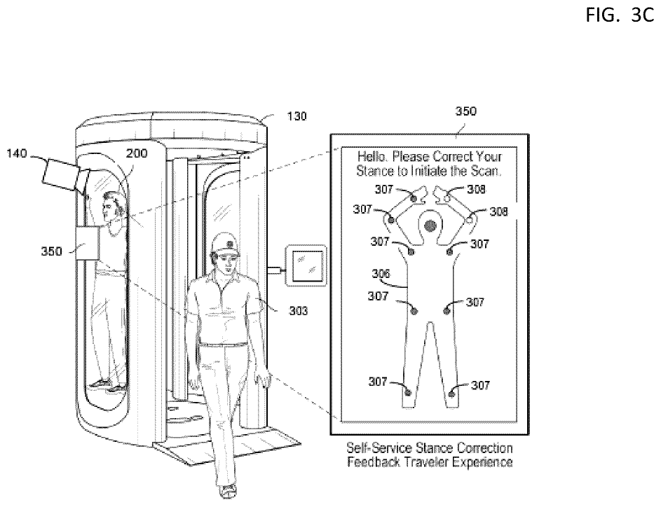

FIG. 3A depicts an object scanner 120 in an exemplary embodiment. Object scanner 120 includes a first position 301a at which to take objects via a receptacle 208 such as a tray via conveyor 210 in a screening direction 301c into scanning chamber 302 where the objects are examined programmatically. The objects are held in chamber 302 until they are cleared. More particularly, in some embodiments, object scanner 120 creates a CT scan of the inducted tray and algorithmically analyses the contents for prohibited objects, for example, USB type devices, and optionally explosive and prohibited weapon threats. Object scanner 120 may provide a full clear automatically by its internal algorithms, or if an object is detected it may make available the image for RMS 170 and/or a remote security operator to review and accept or reject the scan results. All scans may be saved to internal image storage memory regardless if algorithmically cleared. When no objects are detected or the CT scan is cleared by RMS 170 and/or a remote security operator, the case shall be updated, and the tray shall pass to the exit door conveyor queue. In some embodiments, when a subject requires two trays for objects, the second tray may hold inside object scanner 120 until the first tray is removed from the conveyor.

Upon a successful scan indicating no unauthorized objects are on the tray, the receptacle is moved via conveyor 210 to second position 301b where the objects can be retrieved by individual 200 after completing their own successful body scan. In some embodiments, object scanner 120 may be bi-directional in which case objects for scanning may also be deposited at first position 302a to be conveyed in scanning direction 302c into scanning chamber 302 via conveyor 210. Successfully scanned objects may continue to second position 302b for collection by individual 200 after completing their own successful body scan. Such bi-directional capability allows individuals entering or exiting the facility to have the same easy access to a drop off location for object scanner 120 and speeds the clearance process.

In some embodiments, the scan capability of the object scanner 220 is unidirectional. That is, it is only able to accurately scan an object in one horizontal direction. For example, it is able to accurately scan in a horizontal direction from an ingress to an egress of the object scanner 220 and not vice versa. In some embodiments, RMS 170 or the object scanner 220 can detect placement of the receptacle on a section of the conveyor. Depending on the location of the receptacle relative to a designated ingress or egress of the object scanner 220, RMS 170 or the object scanner 220 or some combination thereof can determine if the object scanner 220 can begin scanning of the receptacle or determine if the receptacle needs to be moved from a location near the egress of the object scanner 220, through the object scanner 220 toward the ingress of the object scanner 220 so that the object scanner 220 can scan the objects leaving the secure area.

FIG. 3B depicts a whole body scanner in an exemplary embodiment. As noted above, whole body scanner 130 may use MMW technology to examine individual 200 for hidden unauthorized objects. In some embodiments, with some types of whole body scanners, individual 200 enters the imaging chamber in a forward direction through the entrance and stands at or about a central point in the chamber. The central point can be indicated using instructional markings to aid the individual in understanding how to stand for purposes of scanning such as footprint markings. The individual may turn in a direction orthogonal to an axis that connects the entrance and an exit of the chamber. In other words, the individual turns 90°, often to the right, to face a side direction. Once the individual is in a correct location within the imaging chamber, the individual assumes a scanning position, which is referred to as a ‘pose’. An example of a pose is as follows: The individual places his or her hands over his or her head. Other poses are also possible, such as the individual standing naturally in a relaxed stance with his or her arms at his or her side or with hands placed on hips. Once the individual is in the scanning position (e.g., has assumed the pose), two imaging masts may rotate around the individual on scan paths.

In some embodiments, the imaging masts are connected in a “tuning fork” shaped configuration to a rigid central mount located in a roof of the chamber. Because the two imaging masts are rigidly connected, they both rotate in the same direction, e.g., clockwise or counter-clockwise, and maintain a constant spacing distance between them. The imaging masts include both transmitters and receivers. Each receiver is spatially associated with a transmitter such as by being placed in close proximity so as to form or act as a single point transmitter/receiver. In operation, the transmitters sequentially transmit electromagnetic radiation at a regular rate (e.g. 256 pulses per second) one at a time that is reflected or scattered from the object, and the reflected or scattered electromagnetic radiation is received by two of the respective receivers. A computing device receives signals from the receivers and reconstructs an image of the object using a monostatic reconstruction technique. Hidden objects or contraband may be visible on the image because the density or other material properties of the hidden object differ from organic tissue and create different scattering or reflection properties that are visible as contrasting features or areas on an image. Although an exemplary configuration for a whole body scanner is described above, it should be appreciated that other configurations are also within the scope of the present invention such as those set forth in U.S. patent application Ser. No. 18/126,795, the contents of which are incorporated herein by reference in their entirety.

Based on a received signal a computing device can analyze the strength of a returned pulse, the time it took to travel to the object and back, and the phase or Doppler shift of the pulse to determine if an object has entered the body scanner. The Doppler effect of the electromagnetic radiation can be used to detect when an object enters, exits or is within the scanner, such as an object moving through the scanner. The entrance of the object into the body scanner may be expected or not. For example, the body scanner can determine when an individual has entered the body scanner and initiate a body scanning process. As another example, in a case where an individual is waiting to enter the body scanner, but is in possession of an object that they do not want to enter the body scanner with, the individual may surreptitiously attempt to throw the object through the scanner to try and avoid detection of the object. In such a case, whole body scanner 130 as taught herein is able to detect the object entered the scanner and take an action to alert, for example, security personnel.

In some embodiments, whole body scanner 130 is also equipped with cameras and a display to correct or guide an orientation or a pose or both of an object in any of the systems described herein. Embodiments provide real-time feedback to individual 200 for accurately positioning the individual with a scanning system. According to some embodiments, whole body scanner 130 includes or communicates with a processing system/computing device that can receive information from the cameras about the pose of an individual. The information can be images or information about the images. For example, the information can be images of an individual or information about the location of a body joint of an individual. The processing system can also cause whole body scanner 130 to initiate a scan of the body of the individual responsive to determining that the pose of the individual satisfies a target pose. For example, once the individual achieves a suitable pose, a scan may be performed. As used herein, pose refers to the position or orientation or both of the individual to be scanned and can be the arrangement of the arms and legs, etc. of the individual. In some embodiments, the camera system may also be used for threat identification, for example by detecting an object, such as, but not limited to, a USB hidden between an individual's fingers.

FIG. 3C depicts a display of information to guide the pose of an individual in a whole body scanner in an exemplary embodiment. In an embodiment, individual 200 enters whole body scanner 130. Camera 140 within or otherwise associated with whole body scanner 130 captures images of individual 200 to determine a current pose (e.g., a position and orientation) of the individual and the whole body scanner provides instructions to the individual on how to achieve a desired pose. In some embodiments, the instructions to individual 200 are provided in real-time on how to achieve a desired pose. The instructions on how to achieve the pose may be displayed on a visual display device (e.g., the visual display device 350), such as a monitor or projector. The instructions provide real-time feedback to individual 200 regarding the pose of the individual relative to a target pose 306. For example, the pose 306 can be made up of a plurality of points (e.g., the points 307, 308). In the example of FIG. 3C, the instructions indicate that the pose of individual 200 satisfies the target pose 306 at points 307 but indicates that the pose does not satisfy the target pose 306 at points 308. The instructions may provide visual indicators to provide guidance to individual 200 on how to achieve the target pose 306. In some examples, the instructions may be additional to and/or other than the visual indicators, such as sound instructions (e.g., a voice command), haptic feedback (e.g., vibrations on a certain point of whole body scanner 130), and/or the like including combinations and/or multiples thereof. Once individual 200 achieves the target pose 306, whole body scanner 130 initiates a non-optical scan of the individual as described herein. This process can be performed without intervention from any supervising or managing authority (e.g., an operator) because individual 200 receives positioning instructions from the whole body scanner 130 and/or RMS 170. This decreases the amount of time to perform a scan because individual 200 is receiving real-time feedback on how to achieve the target pose 306. This also improves the quality of the scan performed by whole body scanner 130 because individual 200 is correctly positioned for the scan.

In some embodiments, a linear transceiver array system separate from the imaging masts can be associated with whole body scanner 130 and used to detect objects by emitting and detecting signals and using the Doppler effect associated with those signals to detect the objects. In such an embodiment, the linear transceiver array system may be located at or near an entrance and/or exit of whole body scanner 130 and configured to transmit in a vertical direction (e.g., upwardly or downwardly) to detect ingress or egress of an object into whole body scanner 130.

According to one or more embodiments, one or more cameras can be used in conjunction with or instead of the linear transceiver array system to perform an image-based analysis for detecting objects entering or exiting whole body scanner 130. For example, the cameras can be co-located with the linear transceiver array system and/or used in place of the linear transceiver array system. In such embodiments, the one or more cameras can capture images and/or video, which can be analyzed using a time of flight analysis technique to detect objects entering or exiting whole body scanner 130. In one or more embodiments, aspects of the linear transceiver array system and aspects of the image-based analysis can be merged for detecting objects entering or exiting whole body scanner 130. For example, one of the linear transceiver array system or the image-based analysis can detect an object entering or exiting whole body scanner 130 and the other of the linear transceiver array system or the image-based analysis can verify that the detection was accurate (i.e., dual independent detection).

In some embodiments, light curtains may be employed at the entrances/exits to whole body scanner 130 to provide a continuous “curtain” of light that is monitored for interruptions indicative of objects illicitly traversing the curtain.

An object detected by whole body scanner 130 may result in a scan soft or hard alarm depending on the nature of the object detected. In the case of a soft alarm, the results may be associated with the case ID at RMS 170 and the instructional display is updated with the count of objects found during scanning and direction to the individual to return and divest the additional objects at divest station 120. In the case of a hard alarm for more serious objects, the results may be associated with the case ID at RMS 170 and the instructional display may be updated with a scan failure notification and guidance to individual 200 to remain within whole body scanner 130 until a dispatched security guard arrives. In such a case, both the entry and exit entry light curtains may be armed so that an intrusion alarm will activate if triggered by the individual leaving not withstanding his or her instructions to the contrary. Colored lighting may be used within whole body scanner 130 to convey status information to individual 200 regarding permission to enter and exit in certain embodiments. In some embodiments, the remote security guard is only aware of when an exception arises, for example, a hard alarm. In such embodiments, the remote security guard is not made aware that the individual passes one or more of the screening steps to move past the security checkpoint.

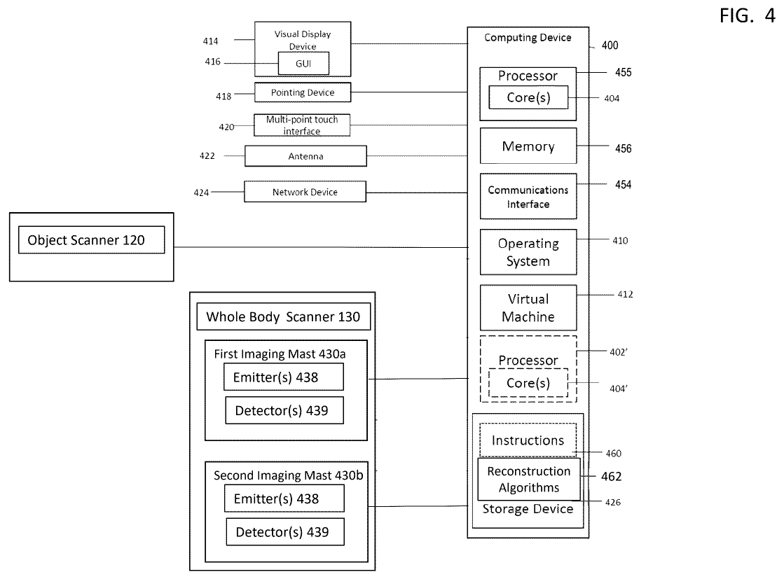

FIG. 4 depicts an exemplary computing device 400 suitable for use with embodiments of the present disclosure. RMS 170 may include one or more instances of computing device 400. Computing device 400 may be, but is not limited to, a smartphone, laptop, tablet, desktop computer, server, or network appliance. Computing device 400 includes one or more non-transitory computer-readable media for storing one or more computer-executable instructions or software for implementing the various embodiments taught herein. The non-transitory computer-readable media may include, but are not limited to, one or more types of hardware memory (e.g., memory 456), non-transitory tangible media (for example, storage device 426, one or more magnetic storage disks, one or more optical disks, one or more flash drives, one or more solid state disks), and the like. For example, memory 456 included in computing device 400 may store computer-readable and computer-executable instructions 460 or software (e.g., instructions to receive data from receivers 439 (also referred to as “detectors”) of the imaging masts 430a, 430b from whole body scanner 130, instructions to receive data from a linear transceiver array system, instructions to selectively enable/disable light curtain devices, instructions to perform image reconstruction methods using monostatic or multi-static reconstruction algorithms, etc.) for implementing operations of computing device 400. Computing device 400 also includes configurable and/or programmable processor 455 and associated core(s) 404, and optionally, one or more additional configurable and/or programmable processor(s) 402′ and associated core(s) 404′ (for example, in the case of computer systems having multiple processors/cores), for executing computer-readable and computer-executable instructions or software stored in the memory 456 and other programs for implementing embodiments of the present disclosure. Processor 455 and processor(s) 402′ may each be a single core processor or multiple core (404 and 404′) processor. Either or both of processor 455 and processor(s) 402′ may be configured to execute one or more of the instructions described in connection with computing device 400.

Virtualization may be employed in computing device 400 so that infrastructure and resources in computing device 400 may be shared dynamically. A virtual machine 412 may be provided to handle a process running on multiple processors so that the process appears to be using only one computing resource rather than multiple computing resources. Multiple virtual machines may also be used with one processor.

Memory 456 may include a computer system memory or random access memory, such as DRAM, SRAM, EDO RAM, and the like. Memory 456 may include other types of memory as well, or combinations thereof.

An individual may interact with computing device 400 through a visual display device 414 (e.g., a computer monitor, a projector, and/or the like including combinations and/or multiples thereof), which may display one or more graphical user interfaces 416. The individual may interact with computing device 400 using a multi-point touch interface 420 or a pointing device 418.

Computing device 400 may also include one or more computer storage devices 426, such as a hard-drive, CD-ROM, or other computer readable media, for storing data and computer-readable instructions 460 and/or software that implements exemplary embodiments of the present disclosure (e.g., applications). For example, exemplary storage device 426 can include instructions 460 or software routines to enable data exchange with one or more imaging masts 430a, 430b, light curtain devices, or a linear transceiver array system. The storage device 426 can also include reconstruction algorithms 462 that can be applied to imaging data and/or other data to reconstruct images of scanned objects, such as using data from the first imaging mast 430a, the second imaging mast 430b, and/or a linear transceiver array system, including combinations thereof.

Computing device 400 can include a communications interface 454 configured to interface via one or more network devices 424 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, computing device 400 can include one or more antennas 422 to facilitate wireless communication (e.g., via the network interface) between computing device 400 and a network and/or between computing device 400, object scanner 120 and/or components of whole body scanner 130 such as imaging masts 430a, 430b, a linear transceiver array system, and/or light curtain devices. The communications interface 454 may include a built-in network adapter, network interface card, PCMCIA network card, card bus network adapter, wireless network adapter, USB network adapter, modem or any other device suitable for interfacing computing device 400 to any type of network capable of communication and performing the operations described herein.

Computing device 400 may run an operating system 410, such as versions of the Microsoft® Windows® operating systems, different releases of the Unix® and Linux® operating systems, versions of the MacOS® for Macintosh computers, embedded operating systems, real-time operating systems, open source operating systems, proprietary operating systems, or other operating system capable of running on computing device 400 and performing the operations described herein. In exemplary embodiments, the operating system 410 may be run in native mode or emulated mode. In an exemplary embodiment, the operating system 410 may be run on one or more cloud machine instances.

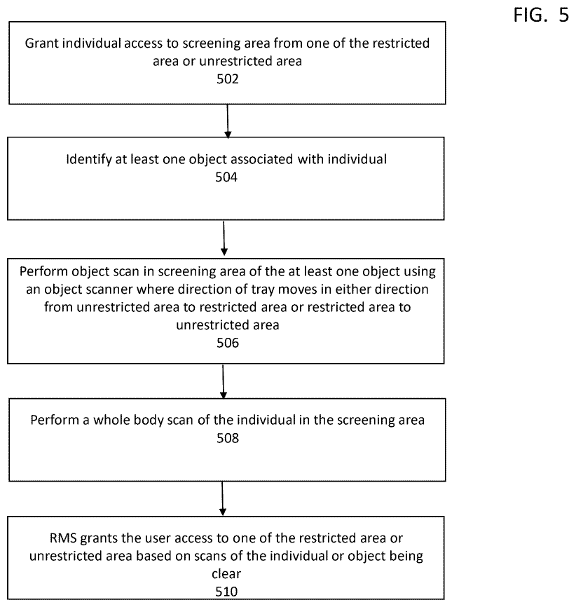

FIG. 5 depicts an exemplary sequence of steps performed to screen individuals and objects in an exemplary embodiment. The sequence begins with granting the individual access to the screening area from either a restricted area or unrestricted area with the screening area disposed between the two (step 502). As discussed herein, such access may be granted following the receipt and verification of identifying information at an entry sensor located outside the screening area. Once within the screening area at least one object associated with the individual is identified (step 504). As previously discussed, the individual may declare objects at a divest station for scanning. The sequence continues with the performing of an object scan by an object scanner in the screening area (step 506). As discussed herein, the divested objects transit the object scanner for examination and may move from the direction of the unrestricted area to the restricted area if the objects are being brought into the secure area or transit the object scanner from the direction of the restricted area to the unrestricted area if the objects are being brought out of the secure area. A whole body scan of the individual is also performed (step 508). Responsive to the individual and the at least one object being cleared by both of the respective scans, the RMS may authorize the individual and the object to enter or exit the secure area (step 510).

Portions or all of the embodiments of the present invention may be provided as one or more computer-readable programs or code embodied on or in one or more non-transitory mediums. The mediums may be, but are not limited to a hard disk, a compact disc, a digital versatile disc, a flash memory, a PROM, a RAM, a ROM, or a magnetic tape. In general, the computer-readable programs or code may be implemented in many computing languages.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

The foregoing description of example embodiments of the invention provides illustration and description, but is not intended to be exhaustive or to limit the invention to the precise form disclosed. Modifications and variations are possible in light of the above teachings or may be acquired from practice of the invention. For example, while a series of acts has been described, the order of the acts may be modified in other implementations consistent with the principles of the invention. Further, non-dependent acts may be performed in parallel.

We claim:

1. A computing device-implemented method for automatically managing access to and from a restricted area without an attendant, the computing device including at least one processor, the method comprising:
granting an individual access to a screening area from one of an unrestricted area or a restricted area, the screening area being disposed between the unrestricted area and the restricted area;
identifying at least one object associated with the individual;
performing, in the screening area, an object scan of the at least one object using an object scanner communicatively coupled to a remote management system (RMS), wherein the at least one object is placed into a tray associated with the object scanner, and wherein the tray is moved through the object scanner based on whether the individual is moving from the unrestricted area to the restricted area or from the restricted area to the unrestricted area as follows:
when the individual is moving from the unrestricted area to the restricted area, moving the tray through a scanning chamber of the object scanner from a first position to a second position while scanning the tray; and
when the individual is moving from the restricted area to the unrestricted area, moving the tray through the scanning chamber of the object scanner from the second position to the first position while scanning the tray;
performing, in the screening area, a body scan of the individual using a whole body scanner communicatively coupled to the RMS; and
responsive to the body scan of the individual passing a body scan clearance protocol and responsive to the object scan of the at least one object associated with the individual passing an object scan clearance protocol, the RMS automatically granting the individual access to the other of the unrestricted area or the restricted area that is different from the area from which the individual accessed the screening area.

2. The method of claim 1, further comprising:
granting the individual access to the screening area based at least in part on verifying an identify of the individual, wherein verifying an identity of the individual is performed using at least one of biometric information associated with the individual, an image of the individual, an identification badge or card associated with the individual, or a password entered by the individual.

3. The method of claim 1, wherein identifying the at least one object associated with the individual comprises logging the at least one object.

4. The method of claim 1, wherein identifying the at least one object associated with the individual is performed by the individual scanning a barcode associated with each of the at least one object to identify the at least one object.

5. The method of claim 1, wherein identifying the at least one object associated with the individual is performed by:
receiving an image of each of the at least one object; and
performing object recognition on the image of each of the at least one object to identify the at least one object.

6. The method of claim 1, wherein identifying the at least one object associated with the individual is performed by sampling contents of the tray of the object scanner with a radio frequency emission detector.

7. The method of claim 1, wherein a radio frequency emission detector monitors the screening area to identify unwanted radio frequency emitters.

8. The method of claim 1 wherein the object scanner includes a bi-directional conveyor belt.

9. The method of claim 1, further comprising:
retaining the tray in the scanning chamber such that the at least one object is inaccessible to the individual responsive to the object scan of the at least one object associated with the individual not being clear.

10. The method of claim 1, further comprising:
performing the body scan and the object scan concurrently.

11. The method of claim 1, wherein performing the object scan is completed prior to performing the body scan.

12. The method of claim 1, further comprising:
capturing an image of the at least one object associated with the individual while performing the object scan, and
associating a scan result of the object scan with the image of the at least one object.

13. The method of claim 1, wherein the object scanner is a computed tomography scanner and the whole body scanner is a millimeter wave scanner.

14. The method of claim 1, wherein the object scan is performed subsequent to verifying that each of the at least one object is on an approved list based on identifying the at least one object.

15. The method of claim 1, further comprising, responsive to the body scan of the individual failing a body scan clearance protocol or responsive to the object scan of the at least one object associated with the individual failing an object scan clearance protocol, alerting the individual or a remotely located security officer.

16. A system for automatically managing security access, the system comprising:
a body scanner to scan an individual;
an object scanner to scan at least one object associated with the individual;
an object identification system to identify the at least one object associated with the individual; and
a processing system comprising:
a memory holding computer readable instructions; and
a processing device for executing the computer readable instructions, the computer readable instructions controlling the processing device to perform operations comprising:
granting the individual access to a screening area from one of an unrestricted area or a restricted area, the screening area being disposed between the unrestricted area and the restricted area;
identifying, using the object identification system, at least one object associated with the individual;
performing, in the screening area, an object scan of the at least one object using the object scanner, wherein the at least one object is placed into a tray associated with the object scanner, wherein the tray is moved through the object scanner based on whether the individual is moving from the unrestricted area to the restricted area or from the restricted area to the unrestricted area as follows:
when the individual is moving from the unrestricted area to the restricted area, moving the tray through a scanning chamber of the object scanner from a first position to a second position while scanning the tray; and
when the individual is moving from the restricted area to the unrestricted area, moving the tray through the scanning chamber of the object scanner from the second position to the first position while scanning the tray;
performing, in the screening area, a body scan of the individual using the body scanner; and
responsive to the body scan of the individual passing a body scan clearance protocol and responsive to the object scan of the at least one object associated with the individual passing an object scan clearance protocol, automatically granting the individual access to either of the unrestricted area or the restricted area.

17. The system of claim 16, further comprising:
a radio frequency emission detector configured to perform at least one of:
sampling contents of the tray of the object scanner to identify the at least one object, or
monitor the screening area to identify unwanted radio frequency emitters.

18. The system of claim 16, further comprising:
a computed tomography scanner.

19. The system of claim 16, further comprising:
a millimeter wave scanner.

20. The system of claim 16, wherein the object scanner includes a bi-directional conveyor belt.
